(19) United States
(12) Patent Application Publication
(10) Pub. No.: US 2025/0002409 A1
(43) Pub. Date: Jan. 2, 2025

(54) HYDRAULIC ECC MATERIAL AND APPLICATION THEREOF

(71) Applicant: CHANGJIANG RIVER SCIENTIFIC RESEARCH INSTITUTE OF CHANGJIANG WATER RESOURCES COMMISSION, Wuhan, Hubei (CN)

(72) Inventors: Jiazheng LI, Wuhan, Hubei (CN); Yan SHI, Wuhan, Hubei (CN); Mingxia LI, Wuhan, Hubei (CN); Xingdong LV, Wuhan, Hubei (CN); Jianfeng ZHANG, Wuhan, Hubei (CN); Yang LI, Wuhan, Hubei (CN); Xiaohu YAN, Wuhan, Hubei (CN); Menghui YANG, Wuhan, Hubei (CN); Zhiqiang XIE, Wuhan, Hubei (CN); Yaqi GONG, Wuhan, Hubei (CN); Wenguang JIANG, Wuhan, Hubei (CN); Liang ZHANG, Wuhan, Hubei (CN)

(73) Assignee: CHANGJIANG RIVER SCIENTIFIC RESEARCH INSTITUTE OF CHANGJIANG WATER RESOURCES COMMISSION, Wuhan, Hubei (CN)

(21) Appl. No.: 18/703,658

(22) PCT Filed: Feb. 16, 2023
(86) PCT No.: PCT/CN2023/076374

§ 371 Date: Apr. 22, 2024

(30) Foreign Application Priority Data
Mar. 23, 2022 (CN) 202210288568.2

(51) Int. Cl. C04B 18/08; C04B 18/14; C04B 20/00; C04B 40/00; C04B 103/30; C04B 103/44

(52) U.S. Cl. CPC C04B 18/08; C04B 18/146; C04B 20/0068; C04B 40/0032; C04B 2103/302; C04B 2103/44

(57) ABSTRACT

A hydraulic engineered cementitious composite (ECC) material and an application thereof are provided. The ECC material includes 25-34 wt % of cement, 23-30 wt % of fly ash, 15-20 wt % of silica fume, 26-32 wt % a fine aggregate, 1.25-1.7% of a composite fiber mesh, 0.1-0.24 wt % of a water reducer, and 0.03-0.07 wt % of a thickener. The composite fiber mesh is prepared by dipping a composite fiber in a water-borne epoxy resin with a curing agent, performing uniform mixing, taking out and spreading the composite fiber, and then cutting or crushing the composite fiber into a small piece of mesh structure; and the composite fiber includes a PVA fiber and a carbon fiber, or a PVA fiber and a basalt fiber, at a weight ratio of (0.3-0.6):1.

### FIELD

The invention belongs to the field of materials for water conservancy projects, and in particular to a hydraulic engineered cementitious composite (ECC) material mainly applicable to corridors, face plates, and sections with anti-cracking requirements, a method for preparing the same, and an application thereof.

### BACKGROUND

Most concrete dam foundations, corridors and face plates for water conservancy projects have the anti-seepage and anti-cracking requirements. Taking the dam foundation as an example, the dam foundation, i.e., the foundation of the dam includes sections for holding a dam body at a riverbed and both banks, as well as adjacent sections for withstanding the actions of the dam body, water body or the like. The stability against seepage and the seepage loss of the dam foundation are the main issues to be addressed in the anti-seepage control of the dam foundation, for which vertical seepage prevention is a common means for addressing such issues effectively. As a weak point of the entire dam body during seepage prevention, the connection between a core wall and an anti-seepage wall is generally done by connecting the core wall of the dam body to a dam foundation corridor disposed at the top of the anti-seepage wall. However, the foundation is uneven since a flat grouting tunnel is disposed on the bed rock and the overburden thickness varies. Therefore, with the filling of the dam body, the corridor undergoes differential settlement in a vertical direction under the action of earth pressure load. After reservoir filling, the anti-seepage wall deforms downstream under the action of earth pressure load, and the corridor also deforms downstream. When the corridor, in particular structural joints, undergoes severe deformation to damage a water stop or the stress on the corridor is overlarge to result in penetrating fractures in the concrete, seepage would occur to the corridor to affect the normal operation of the dam.

An engineered cementitious composite (EEC) material is a high-performance fiber-reinforced cementitious composite material, which overcomes the inherent brittleness of the concrete to produce a large number of fine and dense cracks under the actions of tension, bending or the like, and which can control the maximum crack width to be within 100 μm, showing high ductility, high toughness, and high energy absorption capacity. Therefore, the study of a hydraulic ECC material for a plastic hinged section of the corridor of the dam foundation has a very broad market prospect.

In the prior art, a Chinese patent CN109235174B provides a seamless pavement structure based on fiber-reinforced cementitious composite material, the structure of which includes, from the top down, a covering layer, a cement-concrete pavement layer, a base layer, and a subbase layer. The covering layer is made of a fiber-reinforced cementitious composite material (i.e., the ECC material) with high ductility, high toughness, and high energy absorption rate, and the main components of the ECC material include cement, fly ash, quartz sand, and PVA fibers. As another example, a Chinese patent CN109322238B provides a seamless bridge based on a cementitious composite material with ultrahigh toughness, which includes bridge abutments, foundation beams, and a structural layer. The bridge abutments and the foundation beams are disposed on both sides of the bridge, respectively; each bridge abutment at the side close to the bridge floor is provided with, from the top down, a first asphalt concrete layer, a leveling layer, and a hollow slab; a composite material layer (i.e., the ECC layer) is between the first asphalt concrete layer and the foundation beam; a carbon fiber mesh is horizontally disposed in the middle of the composite material layer and below a horizontal line of the top of the foundation beam. The raw materials of the cementitious composite material with ultrahigh toughness include cement, fly ash, quartz sand, water, admixtures, and PVA fibers. During preparation, the cement, fly ash, quartz, and a thickener are dry-mixed uniformly, then, a water reducer and the water are added, and finally, the PVA fibers are added and stirred till the absence of fiber agglomeration.

However, the studies on these ECC materials largely focus on aspects such as the structure of bridge or pavement, which achieves improved performance by improving the structure. For the corridor of the dam foundation, in particular the structural joints connecting the corridor to the core wall and the anti-seepage wall, there is a lack of studies on the compressive strength, bending strength, and anti-cracking and anti-seepage properties of the ECC material itself

### SUMMARY

In view of the defects in the prior art, the invention provides a hydraulic ECC material, a method for preparing the same, and an application thereof, which are specifically implemented by the following techniques.

The hydraulic ECC material has raw materials including: 25-34 wt % of cement, 23-30 wt % of fly ash, 15-20 wt % of silica fume. 26-32 wt % a fine aggregate, 1.25-1.7% of a composite fiber mesh, 0.1-0.24 wt % of a water reducer, and 0.03-0.07 wt % of a thickener,
wherein the composite fiber mesh is prepared by dipping a composite fiber in a water-borne epoxy resin with a curing agent, performing uniform mixing, taking out and spreading the composite fiber, and then cutting or crushing the composite fiber into a small piece of mesh structure; and the composite fiber includes a PVA fiber and a carbon fiber, or a PVA fiber and a basalt fiber, at a weight ratio of (0.3-0.6):1.

In the above hydraulic ECC material, the cement, fly ash, silica fume, fine aggregate, water reducer, and thickener as used are all common raw materials in the field of concrete building materials. For example, the cement may be commercially available P.O 42.5 ordinary Portland cement (Wuhan Huaxin Cement Company; Sichuan Esheng or the like); the quality of the fly ash meets the technical specification of Class F Grade I fly ash under DL/T 5055-2007 Technical Specification of Fly Ash for Use in Hydraulic Concrete; the quality of silica fume meets relevant technical requirements in DL/T 5777-2018 Technical Specification of Silica Fume for Use in Hydraulic Concrete; the fine aggregate is commercially available common quartz sand, river sand, artificial sand or the like, with the particle size not greater than 1.25 mm; the water reducer is a commercially available high-efficiency polycarboxylic acid water reducer; and the thickener is a common cellulose compound, for example, carboxymethyl cellulose, hydroxypropyl methyl cellulose, or the like. The PVA fiber, carbon fiber, and basalt fiber, as the raw materials of the composite fiber mesh are all commercially available; the water-borne epoxy resin and the corresponding curing agent are also common types available in the market, for example, anionic, cationic, or non-ionic epoxy resins, and common amino-containing alkaline curing agents, for example, a polyamide epoxy 650 curing agent, or the like.

Preferably, the hydraulic ECC material has raw materials including: 30.1 wt % of the cement, 25 wt % of the fly ash, 16 wt % of the silica fume, 27 wt % the fine aggregate, 1.65% of the composite fiber mesh, 0.2 wt % of the water reducer, and 0.05 wt % of the thickener.

Preferably, the composite fiber includes the PVA fiber and the carbon fiber at a weight ratio of 0.45:1, or the PVA fiber and the basalt fiber at a weight ratio of 0.5:1. These fibers may be purchased directly in the market.

More preferably, in the hydraulic ECC material as defined above the composite fiber mesh is prepared by a method specifically including:
S1, uniformly mixing the composite fiber at a weight ratio, adding a resulting mixture to the water-borne epoxy resin, adding the curing agent, and stirring to homogeneity, wherein a usage ratio of the composite fiber to the water-borne epoxy resin is (0.3-0.6):1; and
S2, taking out and spreading the composite fiber on a planar mold, then detaching the completely cured composite fiber from the planar mold, and cutting or crushing the composite fiber into a thin mesh structure with an area of 3-5 mm² and a thickness of 100-150 μm, i.e., the composite fiber mesh.

In the method for preparing the composite fiber mesh, the PVA fiber and the carbon fiber, or the PVA fiber and the basalt fiber, are first mixed uniformly; then, these fibers are added to and dipped in the epoxy resin, and meanwhile, the curing agent is added and mixed uniformly; finally, these fibers are uniformly spread on a platy mold, cured, removed from the mold, and then crushed in a crusher or pulverizer into slices with a specific size and certain flexibility. At the edge of this composite fiber mesh, the composite fibers protrude in alternate arrangement, and meanwhile, the two types of fibers are bonded together by means of the epoxy resin. With the addition of a small amount (1.25-1.7%) of the composite fiber mesh in such a structure, the hydraulic ECC material can be significantly improved in the compressive strength, bending strength, anti-seepage property, and toughness, is also reinforced in the interface adhesive bonding capacity with the old surrounding concrete basal body, and shows certain micro-expansion effect under the hydration heat after pouring.

Preferably, in the method for preparing the composite fiber mesh, the usage ratio of the composite fiber to the water-borne epoxy resin is 0.35:1 in S1.

Preferably, the PVA fiber, the carbon fiber, and the basalt fiber each have a diameter of 25-40 μm and a length of 8-14 mm, which meet the quality requirements of GB/T 21120-2018 Synthetic Fibers for Cement Concrete and Mortar.

A method for using the hydraulic ECC material according to the invention includes: weighing the raw materials of the hydraulic ECC material in percentage by weight, and weighing water at a water-to-cement ratio of 0.32-0.38; uniformly dry-mixing the cement, the fly ash, the silica fume, and the fine aggregate to obtain a solid material, and meanwhile, uniformly mixing the thickener, an air entraining agent, and water to obtain a liquid material; then, pouring the liquid material into the solid material, and performing wet mixing; and finally adding the composite fiber mesh and performing blending to homogeneity to prepare a working material of the hydraulic ECC material for direct pouring.

Preferably, in the method for using the hydraulic ECC material as defined above, the water-to-cement ratio is 0.33.

Compared with the prior art, the invention has the following benefits: the hydraulic ECC material provided by the invention is-tightly crossed and interwoven with other raw materials by adding the composite fiber mesh, to significantly improve the anti-cracking and anti-seepage properties, showing very high mechanical properties such as compressive strength and bending strength; and the invention is very suitable for use in hydraulic ECC pouring materials for sections with anti-seepage and anti-cracking requirements in water conservancy projects.

### BRIEF DESCRIPTION OF THE DRAWINGS

FIG. 1 shows a schematic diagram of poured and molded test specimens for different tests in experimental examples.

### DETAILED DESCRIPTION

The technical solutions of the invention will be described clearly and completely below. Obviously, the embodiments described are merely some of rather than all of the embodiments of the invention. Based on the embodiments of the invention, every other embodiment that can be achieved by a person of ordinary skills in the art without creative efforts shall fall within the protection scope of the invention.

In the examples and comparative examples below, the cement used is the P.O 42.5 ordinary Portland cement from Wuhan Huaxin Cement Company; the fly ash. purchased from Jintang company, is Class F Grade I fly ash under DL/T 5055-2007 Technical Specification of Fly Ash for Use in Hydraulic Concrete; the silica fume is purchased from Wuhan Niuruiqi Company; the fine aggregate is commercial available quartz sand purchased from Henan Dongfu Environmental Protection Company, with the maximum particle size of 1.25 mm and 0.63 mm, respectively; the water reducer is a high-performance PCA water reducer purchased from Sobute New Materials Co., Ltd.; the PVA fiber is purchased from Jiangsu Nengli Technologies Co., Ltd., the carbon fiber is purchased from Weihai GW Composite CO Ltd., and the basalt fiber is purchased from Shandong Senhong Fiber Co., Ltd., and their diameters and lengths vary depending on the example and comparative example, mainly 25-40 μm in diameter and 8-14 mm in length; the thickener is the hydroxypropyl methyl cellulose produced by Shijiazhuang Chuangsheng Building Materials Co., Ltd.; and the water-bone epoxy resin is CYDW-100 from Zhengzhou Wubaotong Commerce & Trade Co., Ltd, and the epoxy resin curing agent is DB from Shenzhen Rongcai Ink Co., Ltd.

In the hydraulic ECC material according to the invention, unless otherwise specially stated, the provided composite fiber mesh is prepared by a method including:
S1, uniformly mixing the composite fiber at a weight ratio, adding a resulting mixture to the water-borne epoxy resin, adding the curing agent, and stirring (at 100 rpm for about 5 min) to homogeneity, where a usage ratio of the composite fiber to the water-borne epoxy resin is determined depending on the example and the comparative example, and the weight ratio of the water-borne epoxy resin to the curing agent is 5:1; and
S2, taking out and spreading the composite fiber on a planar mold, then detaching the completely cured composite fiber from the planar mold, and cutting or crushing the composite fiber into a thin mesh structure with an area of 3-5 mm² and a thickness of 100-150 μm, i.e., the composite fiber mesh.

### Example 1

The hydraulic ECC material provided in this example had raw materials including: 30.1 wt % of cement, 25 wt % of fly ash, 16 wt % of silica fume, 27 wt % a fine aggregate, 1.65% of a composite fiber mesh, 0.2 wt % of a water reducer, and 0.05 wt % of a thickener. The fine aggregate used had the particle size of less than or equal to 1.25 mm.

In a method for preparing the composite fiber mesh, the composite fiber mesh was prepared from a PVA fiber and a carbon fiber at a weight ratio of 0.45:1. The usage ratio of the composite fiber to the water-borne epoxy resin was 0.35:1; and the weight ratio of the water-borne epoxy resin to the curing agent was 5:1.

### Example 2

The hydraulic ECC material provided in this example had raw materials including: 30.1 wt % of cement, 25 wt % of coal ash, 16 wt % of silicon ash, 27 wt % a fine aggregate, 1.65% of a composite fiber mesh, 0.2 wt % of a water reducer, and 0.05 wt % of a thickener. The fine aggregate used had the particle size of less than or equal to 0.63 mm.

In a method for preparing the composite fiber mesh, the composite fiber mesh was prepared from a PVA fiber and a basalt fiber at a weight ratio of 0.5:1. The usage ratio of the composite fiber to the water-borne epoxy resin was the same as that in Example 1.

### Example 3

The hydraulic ECC material provided in this example had raw materials including: 26.05 wt. % of cement, 24 wt % of fly ash, 20 wt % of silica fume, 28 wt % a fine aggregate, 1.7% of a composite fiber mesh, 0.2 wt % of a water reducer, and 0.05 wt % of a thickener. The selection of the fine aggregate and the method for preparing the composite fiber mesh were completely the same as those in. Example 1.

### Example 4

The hydraulic ECC material provided in this example had raw materials including: 28.5 wt % of cement, 23 wt % of fly ash, 15 wt % of silica fume, 32 wt % a fine aggregate, 1.25% of a composite fiber mesh, 0.2 wt % of a water reducer, and 0.05 wt % of a thickener. The selection of the fine aggregate and the method for preparing the composite fiber mesh were completely the same as those in Example 1.

### Example 5

The hydraulic ECC material provided in this example was the same as that in Example 1 in terms of raw materials, with the difference that, in the method for preparing the composite fiber mesh, the PVC fiber and the carbon fiber were at the weight ratio of 0.3:1.

### Example 6

The hydraulic ECC material provided in this example was the same as that in Example 1 in terms of raw materials, with the difference that, in the method for preparing the composite fiber mesh, the PVC fiber and the carbon fiber were at the weight ratio of 0.6:1.

### Example 7

The hydraulic ECC material provided in this example was the same as that in Example 1 in terms of raw materials, with the difference that, in the method for preparing the composite fiber mesh, the ratio of the total weight of the composite fiber to the weight of the water-borne epoxy resin was 0.3:1.

### Example 8

The hydraulic ECC material provided in this example was the same as that in Example 1 in terms of raw materials, with the difference that, in the method for preparing the composite fiber mesh, the ratio of the total weight of the composite fiber to the weight of the water-borne epoxy resin was 0.6:1.

### Comparative Example 1

The hydraulic ECC material provided in this comparative example was the same as that in Example 1 in terms of raw materials, with the difference that, in the method for preparing the composite fiber mesh, the carbon fiber or the basalt fiber was used, and a PVC fiber mesh was used to substitute the composite fiber mesh in Example 1.

The method for preparing the PVA fiber mesh included:
(1) adding a PVA fiber to a water-borne epoxy resin, adding a curing agent, and stirring (at 100 rpm for about 5 min) to homogeneity, where a usage ratio of the PVA fiber to the water-borne epoxy resin was 0.35:1, and the weight ratio of the water-borne epoxy resin to the curing agent was 5:1; and
(2) taking out and spreading the PVA fiber on a planar mold, then detaching the completely cured composite fiber from the planar mold, and cutting or crushing the composite fiber into a thin mesh structure with an area of 3-5 mm² and a thickness of 100-150 μm, i.e., the PVA fiber mesh.

### Comparative Example 2

The hydraulic ECC material provided in this comparative example was the same as that in Example 1 in terms of raw materials, with the difference that a common PVC fiber was used to substitute the composite fiber mesh in Example 1.

### Comparative Example 3

The hydraulic ECC material provided in this comparative example had raw materials the same as those in Example 1, except that the thickener was not used. Specifically, the raw materials included: 30.15 wt % of cement, 25 wt % of fly ash, 16 wt % of silica fume, 27 wt % a fine aggregate. 1.65% of a composite fiber mesh, and 0.2 wt % of a water reducer.

### Test Example: Performance Tests of Test Specimens Made of Hydraulic ECC Material From Examples and Comparative Examples

When the materials prepared in Examples 1-8 and Comparative Examples 1-3 were in use, (1) water was weighed at a specific water-to-cement ratio, the cement, fly ash, silica fume, and fine aggregate were dry-mixed (at 300 rpm for about 2 min) into a solid material, and meanwhile, the thickener (if any), the air entraining agent, and the water are uniformly mixed into a liquid material; and (2) the liquid material was poured into the solid material and wet-mixed (at 500 rpm for about 6 min), and finally, the composite fiber mesh (or ordinary PVA fiber) was added and blended to homogeneity to prepare the working material of the hydraulic ECC material.

### 1. Specifications of Test Specimens for Material Hardening Property Test

The hydraulic ECC test specimens were tested in mechanical, deformation, thermodynamic, and endurance properties in line with DL/T 5150-2017 Test Code for Hydraulic Concrete, JC/T 2461-2018 Standard Test Method for the Mechanical Properties of Ductile Fiber Reinforced Cementitious Composites, CCES01-2004 Guide for Durability Design and Construction of Concrete Structures, JC/T603-2004 Standard Test Method for Drying Shrinkage of Mortar or other regulations. The specifications of hydraulic ECC test specimens were shown in Table 1 below.

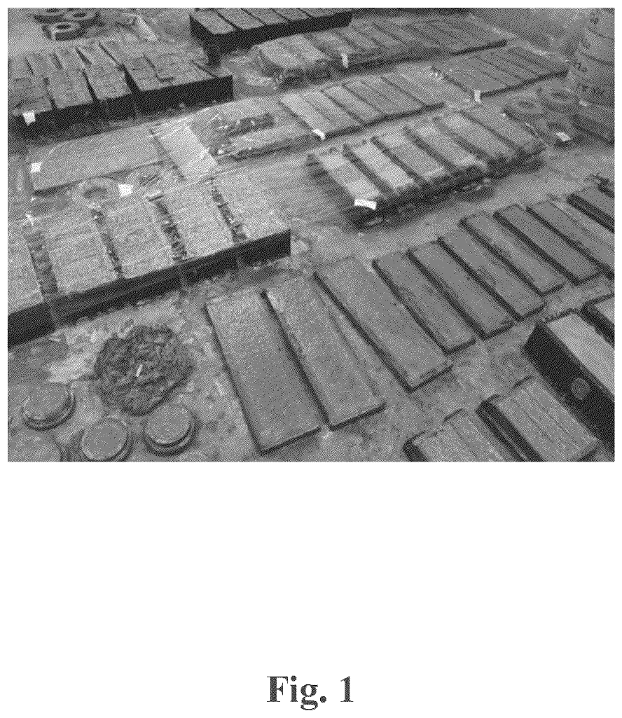

TABLE 1
Specifications of hydraulic ECC test specimens

| Type | Shape | Dimensions |
|---|---|---|
| Cube compressive | Cube | 100 mm × 100 mm × 100 mm |
| strength | | |
| Splitting tensile | Cube | 100 mm × 100 mm × 100 mm |
| strength | | |
| Modulus of | Prismoid | 100 mm × 100 mm × 300 mm |
| elasticity under | | |
| static compressive | | |
| stress | | |
| Direct tensile | Wing | As shown in FIG. 1 |
| property | | |
| Bending strength | Thin | 60 mm × 40 mm × 15 mm |
| | plate | |
| Crack test | Ring | Inner diameter: 120 mm; outer |
| | | diameter: 170 mm; height: 25.4 mm |
| | Slab | 60 mm × 600 mm × 63 mm, |
| | | with external reinforcing ribs |
| Drying shrinkage | Prismoid | 25 mm × 250 mm × 280 mm |
| deformation | | |
| Adhesive property | Cube | 100 mm × 100 mm × 100 mm |
| Anti-freeze | Prismoid | 40 mm × 40 mm × 160 mm |
| property | | |

### 2. Compressive Strength, Splitting Tensile Strength, and Modulus of Elasticity

(1) Tests of cube compressive strength, splitting tensile strength, and modulus of elasticity under static compressive stress were carried out under DLIT 5150-2017 Test Code for Hydraulic Concrete and JC/T 2461-2018 Standard Test Method for the Mechanical Properties of Ductile Fiber Reinforced Cementitious Composites, respectively.
(2) Crack Self-heating Capacity based on strength test

The hydraulic ECC cubic test specimens with the side length of 100 mm were subjected to the 7 d and 28 d compressive strength test, and placed in a curing room for standard curing of 28 d, and then, these specimens were subjected to the second tests of compressive strength and splitting tensile strength, in order to validate the crack self-healing capacity of the hydraulic ECC test specimens from the mechanical perspective.

The test results of compressive strength, splitting tensile strength, and modulus of elasticity were shown in Table 2.

TABLE 2
Test results of compressive strength, splitting
tensile strength, and modulus of elasticity

| | | | | Splitting | | | Modulus | Recuring after | |
|---|---|---|---|---|---|---|---|---|---|
| | Compressive | | | tensile | | | of | breakage | |
| | strength (Mpa) | | | strength (Mpa) | | | elasticity | (MPa) | |
| | 7 d | 28 d | 90 d | 7 d | 28 d | 90 d | (GPa) | 7 d | 28 d |
| Example 1 | 23.6 | 38.1 | 55.8 | 2.48 | 3.59 | 4.08 | 28.4 | 31.9 | 32.1 |
| Example 2 | 24.9 | 39.4 | 56.1 | 2.51 | 3.67 | 4.23 | 29.8 | 32.5 | 32.8 |
| Example 3 | 21.2 | 36.3 | 52.7 | 2.18 | 3.29 | 3.86 | 26.2 | 30.5 | 31.7 |
| Example 4 | 20.1 | 34.9 | 51.5 | 2.07 | 3.12 | 3.74 | 25.5 | 30.1 | 30.4 |
| Example 5 | 21.4 | 37.5 | 54.2 | 2.21 | 3.37 | 3.95 | 27.8 | 31.0 | 31.9 |
| Example 6 | 21.9 | 37.3 | 55.1 | 2.19 | 3.42 | 3.98 | 26.5 | 31.3 | 32.0 |
| Example 7 | 23.1 | 37.9 | 54.7 | 2.37 | 3.48 | 4.04 | 26.4 | 32.1 | 31.3 |
| Example 8 | 23.2 | 38.4 | 55.5 | 2.39 | 3.42 | 3.92 | 25.5 | 31.8 | 32.5 |
| Comparative | 18.5 | 28.7 | 43.7 | 1.69 | 2.32 | 2.96 | 20.5 | 27.3 | 27.4 |
| Example 1 | | | | | | | | | |
| Comparative | 16.7 | 27.2 | 40.1 | 1.56 | 2.02 | 2.79 | 19.6 | 26.4 | 25.3 |
| Example 2 | | | | | | | | | |
| Comparative | 16.1 | 29.2 | 41.2 | 1.49 | 2.11 | 2.74 | 19.5 | 26.6 | 24.3 |
| Example 3 | | | | | | | | | |

### 3. Direct Tensile Property

The hydraulic ECC was tested in direct tensile property according to JUT 2461-2018 Standard Test Method for the Mechanical Properties of Ductile Fiber Reinforced Cementitious Composites. The test specimens for testing direct tensile property were shown in Table 1, with test results shown in Table 3 below.

TABLE 3
Test results of direct tensile property

| | Ultimate tensile | Ultimate |
|---|---|---|
| | strength (Mpa) | elongation (%) |
| Example 1 | 3.94 | 2.59 |
| Example 2 | 4.02 | 2.88 |
| Example 3 | 3.59 | 2.63 |
| Example 4 | 3.36 | 2.49 |
| Example 5 | 3.44 | 2.23 |
| Example 6 | 3.51 | 2.29 |
| Example 7 | 3.96 | 2.52 |
| Example 8 | 3.84 | 2.47 |
| Comparative Example 1 | 2.24 | 1.95 |
| Comparative Example 2 | 2.03 | 1.86 |
| Comparative Example 3 | 1.98 | 0.96 |

### 4. Bending Strength Test

The flat four-point bending test was carried out on the hydraulic ECC test specimens under relevant regulation in JC/T 2461-2018 Standard Test Method for the Mechanical Properties of Ductile Fiber Reinforced Cementitious Composites and DL/T 5150-2017 Test Code for Hydraulic Concrete.

TABLE 4
Test results of bending strength

| | Bending | Displacement at |
|---|---|---|
| | strength (Mpa) | peakload (mm) |
| Example 1 | 14.24 | 3.35 |
| Example 2 | 14.52 | 3.28 |
| Example 3 | 13.63 | 4.41 |
| Example 4 | 13.33 | 4.52 |
| Example 5 | 13.12 | 5.61 |
| Example 6 | 13.39 | 5.69 |
| Example 7 | 14.96 | 3.82 |
| Example 8 | 14.14 | 4.07 |
| Comparative Example 1 | 10.55 | 11.45 |
| Comparative Example 2 | 10.09 | 14.24 |
| Comparative Example 3 | 8.95 | 15.59 |

### 5. Evaluation of Anti-Cracking Property

The anti-cracking test for the hydraulic ECC was carried out by referring to the test method for anti-cracking property of cement and cementitious materials recommended in Appendix A1 of China Civil Engineering Society's CCES01-2004 Guide for Anti-cracking Design and Construction of Concrete Structures (Revision 2005). This test was carried out by referring to the method proposed by S. P. Shah from the US, whereby constraint test specimens made of neat paste or mortar were used to determine the cracking time during their shrinkage, for the purpose of relatively comparing the anti-cracking property to recommend the raw materials and mix ratio of the concrete with better anti-cracking property for projects. A mold for the test specimen included an inner ring, an outer ring, and a base, as shown in the schematic diagram in FIG. 1, and the prepared test specimen was a ring with the following dimensions: inner diameter: 120 mm, outer diameter: 170 mm, and height: 25.4 mm. After one day since the molding of a test specimen, a hoop was removed from the outer ring, and the test specimen and the inner ring were removed and, placed in an environment with the temperature of 20±0.5° C. and the humidity of 50±10%. The anti-cracking capacity of the test specimen under the constraint of the inner ring was evaluated in terms of cracking time, cracking pattern or the like.

The process of the flat-plate anti-cracking test included: first, partitioning a flat plate into three parts with two wooden plates in each of two groups, pouring ordinary concrete at two sides; standing the two groups for 1.5 h and 7 h, respectively; then, pouring the hydraulic ECC material to the middle part; removing templates; performing rapid point vibration on a vibration table; standing for 30 min; and carrying out observation according to the flat-plate anti-cracking test method.

After the hydraulic ECC rings were tested, no cracking was observed, in the test specimens of Examples 1-8, tiny cracks were observed in the test specimens of Comparative Example 1 and 2, and obvious cracks were observed in the test specimen of Comparative Example 3. After the flat-plate anti-cracking test, no cracking was observed in the test specimens of Examples 1-8, about 3-5 tiny cracks were observed in the test specimens of Comparative Example 1 and 2, and nearly 10 obvious cracks were observed in a non-constraint region in the middle of the test specimen of Comparative Example 3.

### 6. Drying Shrinkage Deformation Test

The drying shrinkage test of the hydraulic ECC was conducted by referring to the regulations in JC/T603-2004 Standard Test Method for Drying Shrinkage of Mortar. Specifically, a test specimen of certain length and made of certain glue sand was cured in the air with the specified temperature (20° C.±3° C.) and specified humidity (50%±4%), and the drying shrinkage property of the test specimen of the specified age was determined from its length variation. The hydraulic ECC test, specimens undergoing drying shrinkage were shown in FIG. 1, with the test results shown in Table 5 below.

TABLE 5
Drying shrinkage deformation test

Drying shrinkage rate (×10⁻⁶)

| | 3 d | 7 d | 14 d | 28 d |
|---|---|---|---|---|
| Example 1 | 650 | 930 | 1080 | 1130 |
| Example 2 | 690 | 990 | 1120 | 1158 |
| Example 3 | 550 | 776 | 920 | 1030 |
| Example 4 | 610 | 870 | 1030 | 1100 |
| Example 5 | 600 | 820 | 980 | 1100 |
| Example 6 | 620 | 880 | 1080 | 1115 |
| Example 7 | 680 | 970 | 1100 | 1110 |
| Example 8 | 690 | 980 | 1110 | 1150 |
| Comparative Example 1 | 520 | 740 | 900 | 988 |
| Comparative Example 2 | 450 | 700 | 830 | 955 |
| Comparative Example 3 | 410 | 630 | 750 | 920 |

### 7. Interface Bonding and Rebar Pull-Out Test

To simulate the poured bonding, surface between ECC and ordinary concrete for the corridor of the dam foundation, the laboratory employed the following method to simulate the vertical interface between the two: vertically placing a concrete basal body to half of a cubic test mold of 150 mm; after molding, performing roughening with the depth of 5-10 mm and the spacing of 30 mm to increase the roughness and enlarge the interface for increased interface bonding strength; pouring the ECC material or ordinary concrete to the other side; after the test specimen was molded, performing standard curing for 28 d, and then performing a splitting tensile strength test along the interface.

In combination with the test results in Table 6, the average interface strength of the bonding ECC materials of Examples 1-8 was higher than the concrete of Comparative Examples 1-3. After the smooth bonding of the basal body was destroyed, the test specimen was tested up to the ultimate load, and a bonding face was substantially broken at two sides, and small relief could be directly observed at the fracture surfaces.

TABLE 6
Results of interface bonding and rebar pull-out test

| | Interface bonding |
|---|---|
| | strength (Mpa) |
| Example 1 | 1.48 |
| Example 2 | 1.55 |
| Example 3 | 1.41 |
| Example 4 | 1.37 |
| Example 5 | 1.34 |
| Example 6 | 1.39 |
| Example 7 | 1.50 |
| Example 8 | 1.47 |
| Comparative Example 1 | 1.23 |
| Comparative Example 2 | 1.17 |
| Comparative Example 3 | 1.03 |

### 8. Anti-Freeze Property

Small prismoid test specimens of 40 mm×40 mm×160 mm were molded and subjected to standard curing till 28 d. The anti-freeze capacity of the hydraulic ECC test specimens were tested by referring to relevant regulations of the rapid freeze-thawing test in DL/T5150-2017 Test Code for Hydraulic Concrete. The anti-freeze test results of the hydraulic ECC material were shown in Table 7, indicating that Examples 1-8 meet the design requirement F100 on the anti-freeze level; and after F300 cycles of freeze-thawing, and when the maximum particle size of the sand was not greater than 1.25 mm, the test specimen still met the evaluation standard of DLIT 5150-2017. i.e, the, mass loss of lower than 5% and the relative dynamic modulus of elasticity of greater than 60%.

TABLE 7
Test results of anti-freeze property

| | | | | | | | Relative dynamic modulus | | | | | |
|---|---|---|---|---|---|---|---|---|---|---|---|---|
| | Mass loss (%) | | | | | | of elasticity (%) | | | | | |
| | 25 | 50 | 100 | 150 | 200 | 300 | 25 | 50 | 100 | 150 | 200 | 300 |
| | cycles | cycles | cycles | cycles | cycles | cycles | cycles | cycles | cycles | cycles | cycles | cycles |
| Example 1 | 0.1 | 0.4 | 1.2 | 1.7 | 2.7 | 3.6 | 98 | 96 | 93 | 92 | 87 | 82 |
| Example 2 | 0.2 | 0.4 | 0.9 | 1.5 | 2.5 | 3.4 | 98 | 97 | 93 | 92 | 89 | 82 |
| Example 3 | 0.2 | 0.6 | 1.6 | 2.1 | 2.9 | 4.0 | 98 | 95 | 92 | 90 | 86 | 80 |
| Example 4 | 0.4 | 1.2 | 2.9 | 4.0 | 4.1 | 4.9 | 98 | 96 | 90 | 87 | 84 | 80 |
| Example 5 | 0.6 | 1.2 | 2.6 | 3.7 | 4.3 | 4.8 | 98 | 96 | 90 | 87 | 84 | 79 |
| Example 6 | 0.8 | 1.4 | 3.2 | 4.4 | 4.5 | 5.0 | 96 | 94 | 89 | 85 | 81 | 77 |
| Example 7 | 0.2 | 0.5 | 0.8 | 1.6 | 2.6 | 3.3 | 98 | 97 | 95 | 93 | 90 | 85 |
| Example 8 | 0.2 | 0.4 | 1.0 | 1.4 | 2.6 | 3.5 | 98 | 97 | 94 | 90 | 86 | 83 |
| Comparative | 1.0 | 1.8 | 2.9 | 3.3 | 3.7 | 4.9 | 94 | 90 | 85 | 79 | 72 | 68 |
| Example 1 | | | | | | | | | | | | |
| Comparative | 1.2 | 2.1 | 3.1 | 3.5 | 4.1 | 5.2 | 92 | 86 | 81 | 77 | 71 | 65 |
| Example 2 | | | | | | | | | | | | |
| Comparative | 2.5 | 3.4 | 4.6 | 5.8 | 7.6 | 8.9 | 88 | 81 | 75 | 69 | 61 | 55 |
| Example 3 | | | | | | | | | | | | |

From the test results above, it can be seen that the hydraulic ECC material as prepared with the raw materials and method according to the invention has better resistance to compression, cracking, bending, and freezing and shows a better adhesive property to old surrounding concrete.

1. A hydraulic engineered cementitious composite ECC material, which has raw materials comprising: 25-34 wt % of cement, 23-30 wt % of fly ash, 15-20 wt % of silica fume, 26-32 wt % a fine aggregate, 1.25-1.7% of a composite fiber mesh, 0.1-0.24 wt % of a water reducer, and 0.03-0.07 wt % of a thickener,
wherein the composite fiber mesh is prepared by dipping a composite fiber in a water-borne epoxy resin with a curing agent, performing uniform mixing, taking out and spreading the composite fiber, and then cutting or crushing the composite fiber into a small piece of mesh structure; and the composite fiber comprises a PVA fiber and a carbon fiber, or a PVA fiber and a basalt fiber, at a weight ratio of (0.3-0.6):1.

2. The hydraulic ECC material according to claim 1, which has raw materials comprising: 30.1 wt % of the cement, 25 wt % of the fly ash, 16 wt % of the silica fume, 27 wt % the fine aggregate, 1.65% of the composite fiber mesh, 0.2 wt % of the water reducer, and 0.05 wt % of the thickener.

3. The hydraulic ECC material according to claim 1, wherein the composite fiber comprises the P VA fiber and the carbon fiber at a weight ratio of 0.45:1 or the PVA fiber and the basalt fiber at a weight ratio of 0.5:1.

4. The hydraulic ECC material according to claim 1, wherein the composite fiber mesh is prepared by a method specifically comprising:
S1, uniformly mixing the composite fiber at a weight ratio adding a resulting mixture to the water-borne epoxy resin, adding the curing agent, and stirring to homogeneity, wherein a usage ratio of the composite fiber to the water-borne epoxy resin is (0.3-0.6):1; and
S2, taking out, and spreading the composite fiber on a planar mold, then detaching the completely cured composite fiber from the planar mold, and cutting or crushing the composite fiber into, a thin mesh structure with an area of 3-5 mm² and a thickness of 100-150 μm, i.e., the composite fiber mesh.

5. The hydraulic ECC material according to claim 4, wherein in the method for preparing the composite fiber mesh, the usage ratio of the composite fiber to the water-borne epoxy resin is 0.35:1 in S1.

6. The hydraulic ECC material according to claim 1, wherein the PVA fiber, the carbon fiber, and the basalt fiber each have a diameter of 25-40 μm and a length of 8-14 mm.

7. Application of the hydraulic ECC material according to claim 1, wherein the ECC material is prepared into a working material for direct pouring. the working material of the ECC material being prepared by: weighing the raw materials of the hydraulic ECC material in percentage by weight, and weighing water at a water-to-cement ratio of 0.32-0.38; uniformly dry-mixing the cement, the fly ash, the silica fume, and the fine aggregate to obtain a solid material, and meanwhile, uniformly mixing the thickener, an air entraining agent, and water to obtain a liquid material; then, pouring the liquid material into the solid material, and performing wet mixing; and finally adding the composite fiber mesh and performing blending to homogeneity.

8. The application of the hydraulic ECC material according to claim 7, wherein the water-to-cement ratio is 0.33.
